(19) United States
(12) Patent Application Publication
(10) Pub. No.: US 2002/0047259 A1
(43) Pub. Date: Apr. 25, 2002

(54) Security enhanced document and methods of making the same

(76) Inventors: Claude Lambert, Montreal (CA); Francois Gougeon, Montreal (CA); Robert Boulay, Laval (CA); Denis Mondou, Chateauguay (CA); John C. Abraitis, Cumberland, RI (US); Cayetano Sanchez III, East Greenwich, RI (US); Michael A. Ehrhart, Liverpool, NY (US); Robert M. Hussey, Camillus, NY (US)

Correspondence Address: WATOV & KIPNES, P.C., P.O. Box 247, Princeton Junction, NJ, 08550, US

(21) Appl. No.: 09/933,101

(22) Filed: Aug. 20, 2001

Related U.S. Application Data
(63) Continuation of application No. 09/164,839, filed on Oct. 1, 1998, now abandoned.

(51) Int. Cl. B42D 15/00; G09B 19/00; B42D 15/10

(52) U.S. Cl. 283/49

(57) ABSTRACT

A document, preferably in the form of a lottery ticket has a security system in which a substrate has thereon an encoded game data portion including a base layer printed with an ink having a first reflectance value as measured by the reflectance of a given wavelength of light and a second layer of ink having a second reflectance value together having an encoded pattern of symbols. The encoded game data portion is covered with a scratch-off layer in which improper removal of the scratch-off layer can be detected through either the change in the reflectance pattern of the encoded game data portion or by an alteration in the encoded pattern of symbols.

### FIELD OF THE INVENTION

The present invention is directed to documents having an enhanced security system for protecting against fraudulent tampering thereof. The documents are constructed so that they are readable and analyzable by an optical detector. In a particular embodiment of the invention, the document is an instant scratch-off lottery ticket having a first security system printed beneath the scratch-off layer and an optional second security system printed above the scratch-off layer each system employing layers having different reflectance values and at least one of the systems having an encoded pattern.

### BACKGROUND OF THE INVENTION

Instant scratch-off lottery tickets are well known and comprise a significant industry in the United States and elsewhere. These games have become an important source of revenue for national, state and local governments throughout the world.

Scratch-off lottery tickets are generally divided into several categories; those in the broadest category comprise “instant” lottery games and those of more recent development which comprise “probability” games.

Instant lottery games played with instant scratch-off lottery tickets have game data (i.e. information which determines if a prize has been won) covered by a scratch-off layer which hides the game data from view. The purchaser of the lottery ticket removes the entire scratch-off layer to expose all of the game data. If the game data meets certain criteria to establish a winner, then the purchaser of the ticket wins a set prize. Since the purchaser of the ticket is permitted to expose all of the game data, it necessarily follows that not every such lottery ticket has “winning” game data thereon.

Probability game type lottery tickets also include a scratch-off layer which hides game data from view. However, the probability game ticket permits the ticket purchaser to expose only a portion of the game data according to the rules of the game. Thus, the purchaser is permitted to remove only a portion of the scratch-off layer. Probability game tickets therefore can be printed with winning game data on each ticket because it is the purchaser's selective removal of a portion of the scratch-off layer which determines if a prize has been won. Thus each ticket is a potential winner which is decided in major part by the selected portions of the scratch-off layer that are removed by the purchaser to expose selected portions of the game data.

Both instant and probability game scratch-off tickets may be read by a ticket validating machine. Such machines evaluate a ticket to determine if the ticket is a valid ticket and whether or not it is a winning ticket. Therefore, validating machines must be accurate. They also must provide a rapid evaluation of the ticket to handle the volume of tickets typically sold by a retail establishment without undue inconvenience to the seller and purchaser of the ticket.

The fraudulent tampering of lottery tickets is a continuing problem for the lottery industry. Over the years significant efforts have been made to provide lottery tickets with various means for preventing or at least deterring fraudulent tampering. Fraudulent tampering schemes involving lottery game tickets are often carried out by persons authorized to handle the tickets prior to their official sale. Such persons may be for example, employees of a game ticket manufacturer, employees of a ticket distributer, convenience or grocery store sales clerks, or store owners. Such people who come into contact with lottery tickets have been known to employ various techniques to determine the game data appearing on the ticket. Thus, by engaging in a fraudulent tampering scheme to observe hidden data, the perpetrator can invade tickets before they are sold, select the winning tickets and leave behind the losing tickets of an instant scratch-off lottery ticket type game.

The problem of fraudulent tampering of lottery tickets is enhanced when a probability type game is employed. Since every ticket is potentially a winning ticket, the perpetrators of fraudulent tampering know that successful tampering schemes will necessarily produce a winning ticket. Thus, the perpetrator will seek to determine which portions of the scratch-off layer must be removed to provide a winning ticket. Because each ticket is a potential winning ticket, the perpetrators of such schemes know that invasion of the scratch-off layer will produce a winning ticket. Therefore, the commercial success of probability type lottery games is significantly dependent on the development of anti-tampering measures which at least substantially eliminate fraudulent schemes for determining the game data beneath the scratch-off layer.

There is therefore a need in the industry of security documents and especially scratch-off lottery type games for heightened security against fraudulent detection of game data beneath a scratch-off layer.

It would be a further advance in the art to provide a document having the enhanced security system which is machine readable and can be rapidly read by a validating machine to instantly determine whether a fraudulent tampering scheme has been perpetuated on a particular lottery ticket.

It would be a still further advance in the art to provide a probability game ticket in which each ticket can be rapidly analyzed to determine if no more than the proper number of scratch-off areas have been removed, and that each properly removed scratch-off area has the proper game data.

It would be a still further advance in the art to provide a process by which a lottery ticket with the enhanced security system may be rapidly read and analyzed to determine if it is a valid ticket.

It would be another advance in the art to provide a method by which such tickets having an enhanced security system can be produced.

### SUMMARY OF THE INVENTION

The present invention is generally directed to a document with an enhanced security system in which fraudulent tampering of the document by trying to observe information beneath a scratch-off layer is at least substantially prevented.

The document prepared in accordance with the present invention provides the ability to determine whether a ticket has been tampered with by physical, chemical and other means. In particular, the document of the present invention can be successfully analyzed to detect unauthorized penetration or removal of the scratch-off layer to improperly reveal game data.

In one aspect of the present invention there is provided a document comprising:

a) a substrate;

b) an encoded game data portion imaged on the substrate, said encoded game data portion comprising;

1) a base layer comprising ink having a first reflectance value as measured by the reflectance of a given wavelength of light,

2) a second layer comprising ink having a second reflectance value different than the first reflectance value as measured by the reflectance of said given wavelength of light, said base and second layers defining a game data region and a non-game data region with at least one of said regions having an encoded pattern of symbols associated therewith; and

c) a scratch-off layer over said encoded game data portion.

In an optional further aspect of the present invention, the lottery ticket includes a separate security system printed over the scratch-off layer which has an encoded pattern of symbols associated therewith.

### BRIEF DESCRIPTION OF THE DRAWINGS

The following drawings in which like reference characters indicate like parts are illustrative of embodiments of the invention and are not intended to limit the invention as encompassed by the claims forming part of the Application.

FIG. 1 is a schematic view of an embodiment of a scratch-off lottery ticket in accordance with the present invention;

FIG. 2 is a top view of the play area of a lottery ticket of the present invention with the scratch-off layer removed;

FIG. 3A is a schematic view of a subcell within a cell of the play area of a lottery ticket with an encoded pattern in a first orientation thereon;

FIG. 3B is a schematic view similar to FIG. 3A with the encoded pattern having a second different rotational orientation;

FIG. 3C is a schematic view of a group of subcells as shown in FIG. 3A formed into a cell;

FIG. 4 is a top view of the play area of a lottery ticket shown in FIG. 2 with the scratch-off layer present and an overprinting layer thereon; and

FIG. 5 is a top of the play area of the lottery ticket as shown in FIG. 4 with the scratch-off layer removed from one of the cells.

### DETAILED DESCRIPTION OF THE INVENTION

The present invention is generally directed to a document, especially a scratch-off lottery ticket which has an encoded game data portion imaged on the substrate to provide an effective means for accurately and rapidly detecting fraudulent schemes for improperly determining the game data located beneath a scratch-off layer. The present invention provides for automatic determination of the integrity of the scratch-off layer and recognition of the game data associated encoded pattern by an optical detection system.

As used herein the term “game data portion” shall mean the area of the document that contains game data. The game data portion may be divided into two regions, one region which is the actual symbols or icons used to indicate a prize or play symbol and a second or background region (i.e. non-game data region), typically surrounding the game data. The game data portion is covered by a scratch-off layer. The term “encoded game data portion” shall mean that the game data region, the non-game data region or both have a series of symbols in the form of a detectable pattern which can be read and analyzed by a validating machine, typically employing an optical detection system.

In a first embodiment of the present invention, an encoded game data portion is printed on the substrate which includes a base layer comprising ink having a first reflectance value as measured by the reflectance of a given wavelength of light and a second layer comprised of an ink having a second reflectance value which is different than the first reflectance value. The difference in reflectance values can be detected and analyzed by a validating machine to determine if the ticket is valid or not. The game data provided by the base layer is overprinted with a second layer in an encoded pattern which can be detected by a validating machine to determine authenticity.

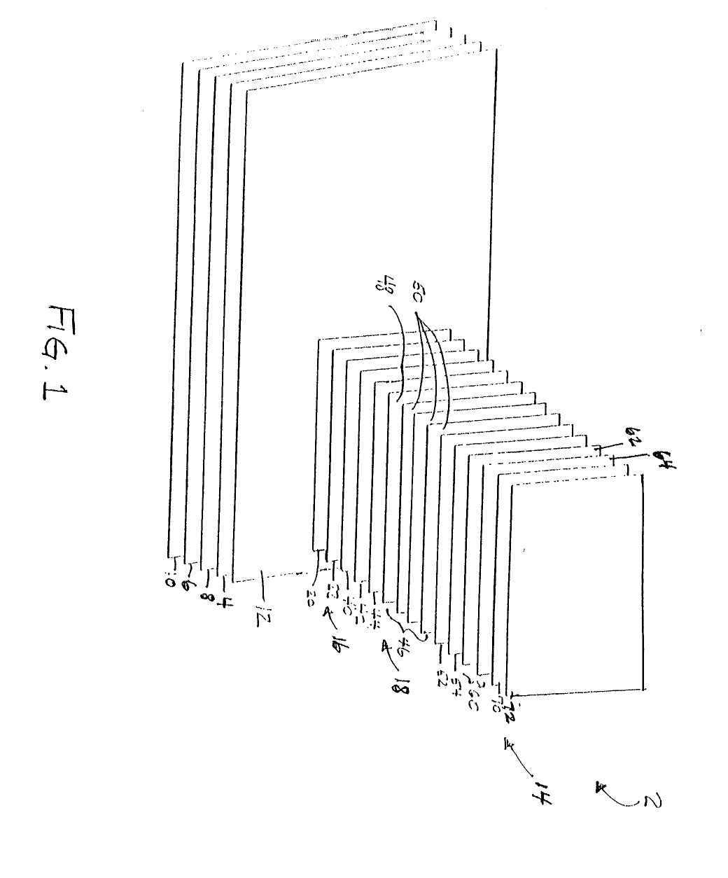

Referring to FIG. 1, there is shown an embodiment of a scratch-off lottery ticket in accordance with the present invention. The lottery ticket 2 generally comprises a substrate 4 which may be made from paper, paperboard, foil laminated to paperboard or the like. For purposes of the present description, the substrate will be in the form of a foil laminated paperboard typically made of aluminum. Substrate 4 has a bottom surface (i.e. made of paper or paperboard) which typically has thereon a bar code printing layer 6, a printed layer containing rules of the game, etc. designated by the numeral 8 and other optional layers 10 such as a varnish or related material used in the scratch-off lottery ticket industry.

Above the surface of the substrate 4 (i.e. in the case of foil laminated tickets, the foil side of the ticket) is a printed layer 12 typically comprised of colorful graphics indicating the theme and/or name of the game. The graphics layer can be printed on the substrate by such methods as screen printing, flexographic printing, offset printing, gravure printing, letterpress printing, and the like. Other layers conventionally employed in scratch-off type lottery tickets such as varnish and lacquer containing layers may also be used where appropriate as would be apparent to those skilled in the lottery ticket art.

Of particular importance to the claimed invention is the area of the ticket known as the play area designated by the numeral 14. The play area can comprise all or a portion of the top side of the lottery ticket. With regard to the present invention, the play area 14 may comprise two regions 16 and 18. Region 16 includes game data, typically in the form of icons or symbols providing information as to the type of prize that may be won. The second region 18 includes protective varnishes, one or more scratch-off layers and one or more layers generally referred to as overprinting layers. The region 16 as explained in detail hereinafter, contains a first system for combating fraudulent tampering of the lottery ticket. The second region 18 may contain an optional second system for combating fraudulent schemes for detecting the particular game data located beneath the scratch-off layer. The systems for combating fraudulent tampering are desirably machine readable by an optical detection system as described hereinafter.

The first region 16 includes at least one base layer 20 which is printed with an ink having a first reflectance value as measured by the reflectance of a given wavelength of light. As used herein the term “reflectance” shall mean the fraction of the total radiant flux incident upon a surface that is reflected and that varies according to the wavelength distribution of the incident radiation.

The preferred given wavelength of light is red light having a range of wavelengths within the red visible spectrum. Other wavelengths of light (e.g. white light) may be employed. In a preferred form of the invention, the reflectance value of the base layer 20 is from about 23 to 43% reflectance. In a preferred form of the invention, the percentage of reflectance of the base layer 20 is about 33%. This means that 33% of red light from a source when contacted with the base layer 20 will be reflected from the surface of the base layer. The light reflected is detectable by a validating machine.

The first region 16 further includes a second layer 22. The second layer is comprised of an ink having a second reflectance value (e.g. from about 0 to 10% reflectance preferably 0% reflectance) which is different than the first reflectance value of the base layer 20, based on the same given wavelength of light (e.g. red light). The difference of the reflectance values between the two layers 20, 22 must be detectable by a validating machine and preferably by an optical detector system contained therein. In other words, it is necessary for the validating machine to be able to differentiate between the base layer and the second layer when the lottery ticket is placed into operable contact with the optical detecting device, typically contained within the validating machine.

The game data in the play area is formed by the base layer 20 and the second layer 22. Because the respective layers have different reflectance values, each layer is distinguishable from the other layer by the human eye. The game data can therefore be formed by applying the base layer 20 as a continuous coating and printing the second layer 22 thereover in a pattern that allows the base layer 20 to be seen as game data (e.g. a letter or a number). Alternatively, the base layer 20 can be applied only in the form of the game data and the second layer can be placed around the game data to provide the necessary contrast. In a further embodiment the second layer 22 can be printed as the game data over the base layer 20. The cooperation of the two layers therefore provides the play area with game data in the color of one of the layers 20, 22 which is observable because of the contrast with the other of said layers.

The play area includes at least one game data associated encoded pattern. The term “game data associated pattern” means that the play area contains a pattern of symbols which can be detected by a validating machine and typically by an optical detecting device contained within the validating machine. If the proper pattern of symbols is present, the validating machine will view the document as a valid document. If the pattern of symbols has been altered or removed, the pattern will not be detected by the validating machine and the document will be viewed as invalid.

The encoded pattern of symbols can be formed in the play area in the same way the game data is formed by the manner in which the base layer and second layer are applied to the substrate. Thus, the encoded pattern can be formed on the game data and/or the area in proximity to the game data (i.e. the non-game data region). Furthermore, the pattern of symbols can be formed by the base layer or the second layer or both as described in detail hereinafter.

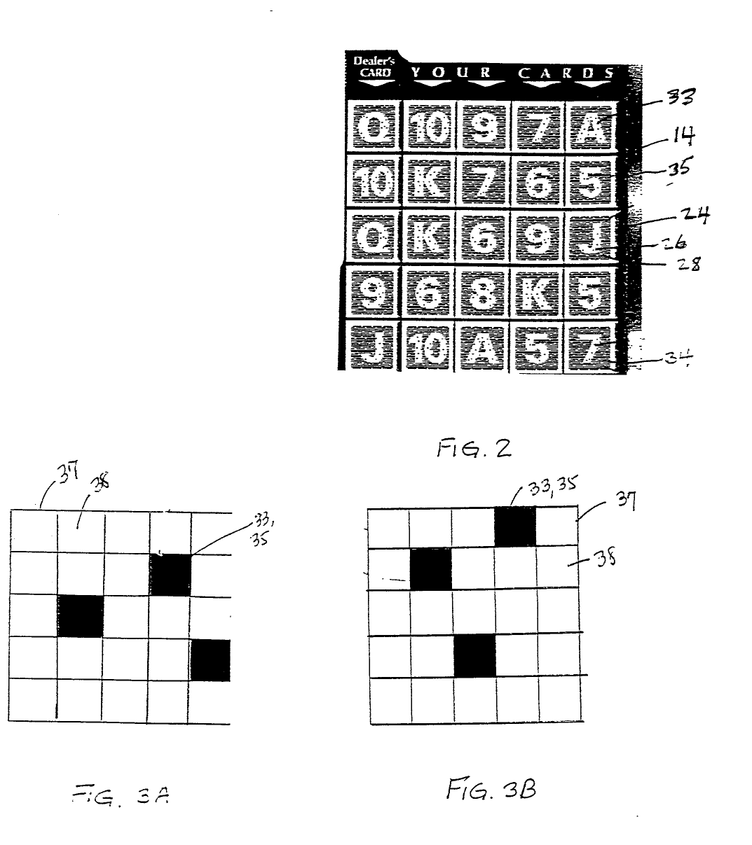

By way of example and hereinafter describing a first embodiment of the invention FIG. 2 shows the play area 14 of a lottery ticket in accordance with the present invention. The play area 14 is divided into a series of game data containing cells 24 with each cell containing game data 26 in the form of numbers 5 to 10 and letters J, Q, K and A and a background or non-game data region 28.

The game data region 26 is provided in one exemplary method of the present invention by first printing each cell 24 containing game data with a base layer 20 in the form of an ink having a first reflectance value. An example of an ink useful for the base layer is one which is ink jet receptive of a desired color such as PMS-375 which is a reference color known in the printing industry. A second layer 22 of ink selected from other PMS references is then printed over the base layer 20 in a manner which forms the game data region 26 and the non-game data region 28 of the cell 24.

The play area 14 and particularly each cell 24 contains an encoded pattern of symbols as explained hereinafter which can appear in the game data region 26 and/or the non-game data region 28. As shown specifically in FIG. 2, the identified symbols appear as “dots” and are identified by numeral 33 present in the game data region 26 and by numeral 35 in the non-game data region 28.

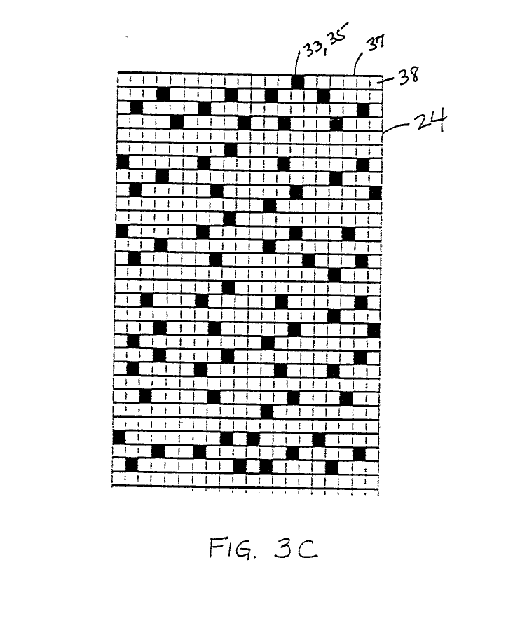

The symbols 33 appearing in the game data region 26 are formed by printing the symbols in the ink forming the second layer 22 on top of the ink forming the base layer 20. Thus, as shown in FIG. 3A the symbols 33 (e.g. dots) appear dark relatively to the lighter game data. The symbols 35 appearing in the non-game data region 28 are formed by printing the second layer over the base layer in a discontinuous manner to leave the pattern of dots in the color of the base layer. Thus, in the non-game data region 28, the dots appear from the base layer as lighter than the overlying, darker second layer.

It will be understood that the symbols can be printed on the game data region 26, the non-game data region 28 or in both regions as specifically shown in FIG. 2.

The symbols 33, 35 (e.g. dots) are arranged in a pattern that can be detected by a validating machine (i.e. an encoded pattern). The pattern of the symbols 33, 35 is sufficient if it can be detected by the validating machine preferably by an optical detecting device contained therein so fraudulent manipulation of the base layer 20 or the second layer 22 will affect the pattern causing the validating machine to differentiate a ticket that has been tampered with and one that has not.

The pattern of symbols which is selected for the document should be one that is not readily recognized by casual observance. Patterns of symbols can be developed for example by dividing each cell 24 of the play area 14 into a plurality of subcells as shown in FIG. 3C. Each subcell as shown in FIGS. 3A and 3B comprises a grid of spaces. Some of the spaces will show ink corresponding to the base layer and some corresponding to the second layer according to the selected pattern of symbols. The spaces which are filled with one of the inks thereby forming the “dots” can be selected such that the dots are in a machine readable pattern.

Referring to FIG. 3A, there is shown a subcell 37 containing, for example, twenty-five spaces 38. As shown specifically in FIG. 3A symbols 33, if the subcell 37 is from the game data region 26, or symbols 35 if the subcell 37 is from the non-game data region 28, are identified as part of an encoded pattern. As shown specifically in FIG. 3A, three symbols 33, 35 form the encoded pattern from all of the symbols that may be contained within an individual subcell 37. If this particular arrangement of three symbols is detected, regardless of the rotational orientation then the validating machine will accept the ticket as valid.

The orientation of the symbols 33, 35 as specifically shown in FIG. 3A can be rotated in a plane about an axis perpendicular to the plane of rotation to have the appearance as shown in FIG. 3B (i.e. the pattern of symbols may be rotated and still be read by the validating machine). Although the untrained eye may view the pattern in FIG. 3B as different than that of FIG. 3A, nonetheless, the validating machine can interpret the arrangement of the three symbols in FIG. 3B to be the equivalent of the arrangement of FIG. 3A. On the other hand, if the particular arrangement, regardless of orientation, is not shown, the validating machine will interpret the ticket as an invalid ticket.

The pattern of symbols described with reference to FIGS. 3A-3B is of the type that is both uniform and complimentary. The pattern is uniform because the same subcell arrangement of symbols as shown in FIG. 3A is employed throughout the cell, differing only by the orientation of the pattern in a plane about an axis perpendicular to the plane of orientation as shown for example in FIG. 3B. The pattern, as shown best in FIG. 3C, is complimentary because the same pattern exists both in the game data region 26 and the non-game data region 28.

It will be understood that other patterns may be employed including patterns which are uniform but not complimentary, complimentary but not uniform or neither uniform or complimentary. For example, a pattern of symbols (e.g. dots) may be applied to only the game data region while a non-game data region has a continuous coating of the base and/or second layers of ink. The pattern of symbols may be applied to only the non-game data region leaving the game data region with only, for example, a continuous coating of the base layer.

The pattern of symbols within any one region 26, 28 need not be uniform. For example, the less than all of the subcells within a region may be provided with the pattern of symbols. Thus, some of the subcells will contain the pattern and some will not (e.g. those cells that do not contain the pattern may contain a random arrangement of symbols or may contain a separate and distinct pattern of symbols).

Referring again to FIG. 2, it can be seen that the symbols 33, 35 arranged in the cells 24 of the game ticket can be employed as an effective anti-tampering system. If the arrangement of symbols 33, 35 regardless of the pattern selected is disrupted because of tampering, the validating machine will interpret the ticket as an invalid ticket and any prize can be refused.

Thus, the anti-tampering system disclosed with reference to FIGS. 1-3C enable the detection of fraudulent schemes to tamper with tickets by first providing two layers of inks defining the game data having different reflectance values which can be detected by a validating machine. If the position of the two ink layers (i.e. the base layer and the second layer) in any one of the cells is altered, the alteration can be detected by the validating machine and the ticket will be rendered invalid. The second anti-tampering system also employs the symbols in an encoded pattern arranged in at least some of the cells. If the encoded pattern such as that shown with reference to FIGS. 3A-3C is altered or disrupted, this will be viewed as an invalid ticket by the validating machine.

As previously indicated with reference to FIG. 1, the lottery ticket of the present invention includes a scratch-off layer covering the game data. As shown specifically in FIG. 1, the game data portion 16 comprised of the base layer 20 and second layer 22 is typically covered with one or more varnish layers (three layers are shown in FIG. 1) which are designated as layers 40, 42 and 44 in FIG. 1. By way of example, two of the layers can contain a clear varnish material customarily used as a protective layer for lottery tickets. The upper most layer 44 is preferably an ultraviolet cured release layer typically made from free radical acrylates which protects the ticket from fraudulent tampering especially by chemical means. More specifically, the ultraviolet cured release layer provides a solid, physical barrier against penetration by common chemicals such as solvents and the like. The ultraviolet cured release layer is also known to facilitate removal of the scratch-off layer because it provides a smooth surface upon which the scratch-off layer is applied.

Again referring to FIG. 1, a scratch-off system designated by the numeral 46 provides an opaque covering for the game data so that the purchaser cannot view the game data without removing the scratch-off system 46. By way of example, the scratch-off system 46 includes at least one layer of an opaque latex typically a black latex opaque coating 48 and at least one, preferably more than one white opaque latex coating 50. As shown specifically in FIG. 1, three layers of the white opaque coating are shown.

The black latex opaque coating 48 prevents viewing of the game data while the white latex opaque coating 50 provides a foundation for the overprinting of various other layers including ink layers as described in detail hereinafter. In accordance with a further aspect of the present invention, there is provided an optional second security system applied above the scratch-off system 46. The second system is comprised of at least two different ink layers including a base layer with an ink having a third reflectance value as measured by the reflectance of a given wavelength of light and a second layer comprising an ink having a fourth reflectance value different than the third reflectance value. The base layer and/or the second layer may contain an encoded pattern of symbols.

The formation of the encoded pattern of symbols can be achieved in the second security system by printing the second layer over the base layer or by reversing the arrangement of layers. Thus, the symbols (e.g. dots) may be in the color of the base layer or the second layer.

An embodiment of a second security system 60 is shown in FIG. 1. The system 60 is comprised of two layers 62 and 64. The base layer or lower layer 62 comprises an ink having a reflectance value which is preferably different than the reflectance values of layers 20 and 22 previously described and is different than the reflectance value of the upper, second layer 64. The reflectance value of the base layer 62 is preferably from about 90 to 100% reflectance (based on the reflectance of red light) as previously described in connection with the first security system, most preferably about 100% reflectance. The base layer 62 is printed over the white latex layers 50 to completely cover the cells 24 of the play area 14 of the ticket as previously described.

The upper layer 64 is printed in an ink having a different reflectance value than the underlying layer 62. Preferably, the reflectance value of the layer 64 is lower than the layer 62 and is from about 57 to 77% reflectance (based on the reflectance of red light), most preferably about 67% reflectance.

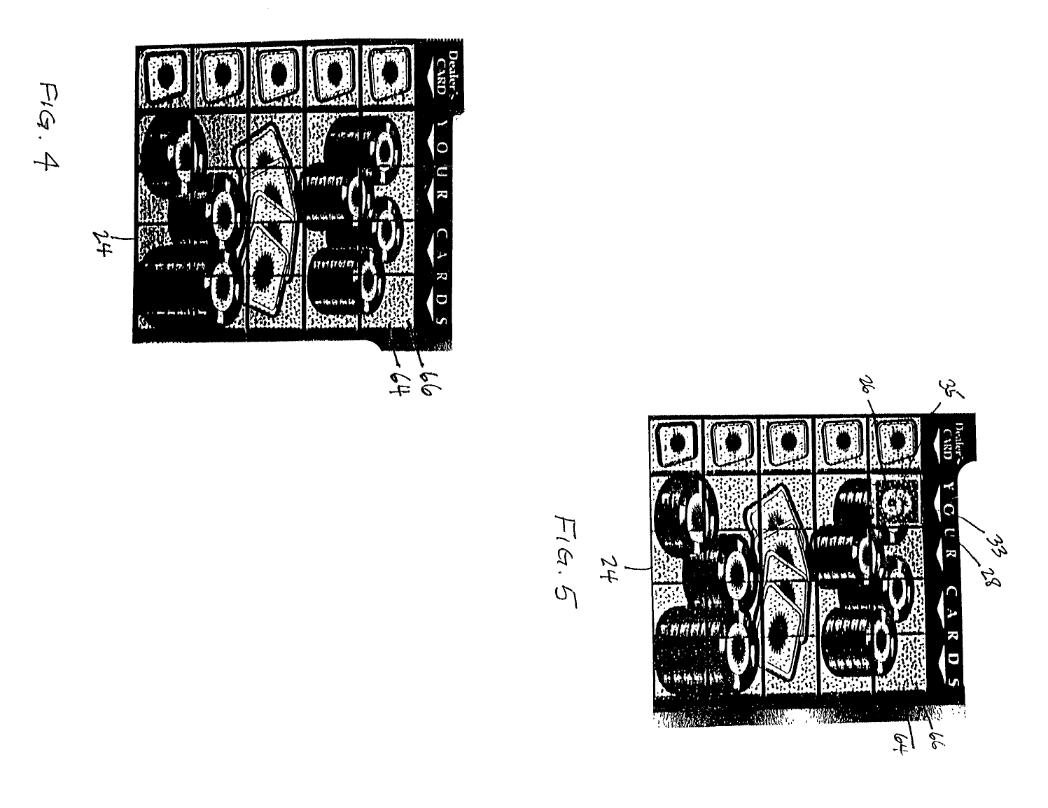

The second layer 64 is printed over the base layer 62 in a manner such that an encoded pattern of symbols 66 is provided as shown in FIG. 4. There is provided a base layer 62 having overprinted thereon a second layer 64 in which the second layer is imprinted in a manner that symbols 66 in the color of the first layer appear on the ticket in an encoded pattern. The symbols 66 can be in any form such as in the form of dots as shown in FIG. 4.

The pattern of symbols can be formed in the same way as previously described for the first security system including a uniform pattern, a complimentary pattern, neither uniform or complimentary or both uniform and complimentary. The symbols 66 are arranged in a pattern in a manner which enables decoding by a validating machine typically containing an optical detection system so that if the pattern of the symbols is altered in one or more cells of the ticket, the validating machine can detect the tampering and indicate that the ticket is invalid.

The second anti-tampering system 60 which appears above the scratch-off layer system 46 and therefore is visible to the purchaser of the ticket before the ticket is played provides at least two measures of security. First, a ticket at the time of the purchase will have all of the cells of the ticket emitting a first reflectance value corresponding to one of the layers 62, 64 of the second security system 60 and a second reflectance value corresponding to the encoded pattern of symbols from the other of said layers 62, 64. If the scratch-off system 46 is penetrated to observe game data therebelow, the validating machine will detect a change in the reflectance pattern because at least some of the reflectance from layers 22 and or 20 will be present. The validating machine will be able to differentiate between the four layers 20, 22, 62 and 64 because of their respective different reflectance values and if the expected reflectance values are not present the ticket can be declared invalid. In addition, if the encoded pattern of symbols 66 appearing in one or more of the cells of the game area is altered or disrupted, the validating machine will be able to detect this alteration and render the ticket invalid.

In a typical probability game ticket, the purchaser is requested to remove the opaque latex layers in less than all of the cells in the game area. As specifically shown in FIG. 5, and for purposes of illustration only, the opaque latex system remains intact except for a single cell appearing in the top left hand corner of the game area. This particular cell has the latex system properly removed to expose game data in the form of the number “6”. If any one of the other cells was scratched contrary to the rules of the game, that scratch could be detected by the validating machine because the reflectance values of at least one of the layers 20, 22 would be detected in that cell when only the layers 62 and 64 should be detected.

If as shown in FIG. 5, there was an attempt to change the game data appearing in the properly exposed cell, such tampering could be detected by the encoded pattern of symbols appearing in the first security system as previously described in connection with FIG. 2.

Accordingly, documents employing a scratch-off layer system and especially lottery tickets for probability games exhibit enhanced security by the employment of at least the first security system of the present invention described with reference to FIGS. 1-3C and especially good results are obtained by the incorporation of both security systems encompassed by FIGS. 1-5.

The detection of the layers 20, 22, 62 and 64 based on different reflectance values can be accomplished by conventional means through the employment of an optical detection system including a light source (e.g. for red light from a red LED) which is transmitted into the path of the lottery ticket within a validating machine. Light rays which are reflected from the ticket will be detected by an image sensor (e.g. single element photodetector) which will read portions of the ticket (i.e. pixels) with a typical definition of 330 dpi (dots per inch). The pattern read will be compared to a stored pattern for that ticket. The optical detection system will select the desired stored pattern based on the reading of a bar code appearing typically on the backside of the ticket.

The optical detection system typically differentiates reflectance on a scale of 0 to 255, with 0 being black and 255 being white. Thus, 67% reflectance will be indicated on the above scale as having a value of about 164. 33% reflectance will be indicated on the above scale as having a value of about 82.

Some efforts at fraudulently tampering with lottery tickets seek to “repair” the ticket so that the validating machine is tricked into reading the ticket as a valid ticket. To address this problem, there is provided in a preferred form of the invention at least one layer 70 which is invisible to the human eye but sensitive to a detectable wavelength of light such as near infrared. The layer 70 will absorb in the near infrared light about 680 nm and reflect in the near infrared in about 720 nm. If attempts are made to replace the scratch-off layers by any other similar printed layers or photocopies of these scratch-off layers are placed over the game area (cell). The absence of this near infrared reflectance layer will be detected by the validating machine. The layer 70 is preferably made from a near-infrared fluorescent dye available from Eastman Chemical and is formulated into a printing varnish to be applied over at least the scratch-off layer of the ticket.

What is claimed is:

1. A document comprising:
a) a substrate;
b) an encoded game data portion imaged on the substrate, said encoded game data portion comprising:
1) a base layer printed with an ink having a first reflectance value as measured by the reflectance of a given wavelength of light;
2) a second layer comprising an ink having a second reflectance value different than the first reflectance value as measured by the reflectance of said given wavelength of light;
wherein the base layer and the second layer together define a game data region and a non-game data region with at least one of said regions comprising an encoded pattern of symbols associated therewith; and
c) at least one scratch-off layer over said encoded game data portion.

2. The document of claim 1 wherein the second reflectance value is less than the first reflectance value.

3. The document of claim 1 wherein the given wavelength of light is a red light.

4. The document of claim 1 wherein the second reflectance value is from about 0 to 10% reflectance.

5. The lottery ticket of claim 1 wherein the second reflectance value is 0% reflectance.

6. The lottery ticket of claim 1 wherein the first reflectance value is from about 23 to 43% reflectance.

7. The lottery ticket of claim 6 wherein the first reflectance value is about 33% reflectance.

8. The document of claim 1 wherein the encoded pattern of symbols is present in at least one of the game data region and the non-game data region.

9. The document of claim 8 wherein the encoded pattern of symbols appears in both the game data region and the non-game data region.

10. The document of claim 8 wherein the encoded pattern of symbols appears in less than the entire game data region or the non-game data region.

11. The document of claim 8 wherein the encoded pattern of symbols comprises a fixed arrangement of said symbols in more than one rotational orientation.

12. The lottery ticket of claim 8 wherein the encoded pattern for at least one said regions is different than the encoded pattern for another of said regions.

13. The lottery ticket of claim 8 wherein the encoded game data portion comprises at least one cell having a game data region and a non-game data region, each of said game data and non-game data regions having said base layer printed thereon, said game data region further comprising said second layer printed thereon in a first encoded pattern of symbols.

14. The lottery ticket of claim 13 wherein the non-game data regions have said second layer printed thereon in a manner which leaves a second encoded pattern thereon.

15. The document of claim 14 wherein the non-game data region comprises a second layer with a non-game data associated encoded pattern of symbols from said base layer present thereon.

16. The document of claim 1 further comprising at least one additional layer printed over the at least one scratch-off layer and having a scratch-off layer associated encoded pattern thereon.

17. The document of claim 16 wherein said additional layer comprises,
3) a third layer printed with an ink having a third reflectance value as measured by said given wavelength of light;
4) a fourth layer printed with an ink having a fourth reflectance value different than the third reflectance value, as measured by said given wavelength of light.

18. The document of claim 16 wherein the fourth reflectance value is less than the third reflectance value.

19. The document of claim 18 wherein the third reflectance value is from about 90 to 100% reflectance.

20. The document of claim 19 wherein the third reflectance value is 100% reflectance.

21. The document of claim 20 wherein the fourth reflectance value is from about 57 to 77% reflectance.

22. The document of claim 21 wherein the fourth reflectance value is about 67% reflectance.

23. The document of claim 16 wherein the scratch-off layer associated pattern comprises an encoded pattern of symbols over at least a portion of the scratch-off layer.

24. The document of claim 23 wherein said second encoded pattern of symbols comprises a fixed arrangement of symbols in more than one rotational orientation.

25. The document of claim 17 wherein the additional layer covers a plurality of cells, each cell with the second encoded pattern comprising symbols of said fourth layer printed on the third layer.

26. The document of claim 1 further comprising a layer invisible to the human eye which has a preselected reflectance value for a given wavelength of light.

27. The document of claim 26 wherein said layer reflects the near infrared spectrum.

28. The document of claim 1 in the form of a lottery ticket.

29. A method of detecting tampering of a document comprising:
a) a substrate;
b) an encoded game data portion imaged on the substrate, said encoded game data portion comprising:
1. a base layer printed with an ink having a first reflectance value as measured by the reflectance of a given wavelength of light;
2. a second layer comprising an ink having a second reflectance value different than the first reflectance value as measured by the reflectance of said given wavelength of light;
wherein the base layer and the second layer together define a game data region and a non-game data region with at least one of said regions comprising an encoded pattern of symbols associated therewith; and
c) at least one scratch-off layer over said encoded game data portion,
said method comprising contacting said document with said given wavelength of light, detecting a reflectance value of said document obtained from said contacting step and comparing said reflectance value with a reflectance value from a standard value for said document.

30. The method of claim 29 comprising detecting the reflectance value of at least one of said base layer and said second layer.

31. The method of claim 30 comprising detecting the reflectance value of said encoded pattern of symbols.

32. The method of claim 29 wherein said document further comprises at least one additional layer printed over the at least one scratch-off layer and having a scratch-off associated encoded pattern thereon, said method further comprising detecting the reflectance value of said additional layer and comparing said reflectance value with a reflectance value obtained from a standard value for said document.

33. The method of claim 29 wherein said document further comprises a layer invisible to the human eye which has a preselected reflectance value for a given wavelength of light, said method comprising contacting said document with said give wavelength of light, detecting the reflectance value of said invisible layer and comparing the reflectance value with the reflectance value from a standard value for said document.

34. The method of claim 33 comprising contacting the document with a near infrared light source.

35. A method of producing a tamper resistant document comprising applying to a substrate an encoded game data portion which comprises:
1. a base layer printed with an ink having a first reflectance value as measured by the reflectance of a given wavelength of light;
2. a second layer comprising an ink having a second reflectance value different than the first reflectance value as measured by the reflectance of said given wavelength of light;
wherein the base layer and the second layer together define a game data region and a non-game data region with at least one of said regions comprising an encoded pattern of symbols associated therewith; and
applying at least one scratch-off layer over said encoded game data portion.

36. The method of claim 35 further comprising applying at least one additional layer over the scratch-off layer having a scratch-off layer associated encoded pattern thereon.

37. The method of claim 36 comprising applying a third layer printed with an ink having a third reflectance value as measured by said given wavelength of light and applying a fourth layer printed with an ink having a fourth reflectance value different from the third reflectance value as measured by said given wavelength of light.

38. The method of claim 35 further comprising applying a layer invisible to the human eye which has a preselected reflectance value for a given wavelength of light.

39. The method of claim 38 wherein the given wavelength of light is from the near infrared spectrum.
